(19) United States
(12) Patent Application Publication
(10) Pub. No.: US 2013/0132342 A1
(43) Pub. Date: May 23, 2013

(54) System, Method and Computer Readable Storage Medium for Data Synchronization

(71) Applicant: Chia Hung Kao, Taitung City (TW)

(72) Inventor: Chia Hung Kao, Taitung City (TW)

(73) Assignee: INSTITUTE FOR INFORMATION INDUSTRY, Taipei (TW)

(21) Appl. No.: 13/316,727

(22) Filed: Dec. 12, 2011

(30) Foreign Application Priority Data
Nov. 21, 2011 (TW) 100142594

(51) Int. Cl. G06F 7/00

(52) U.S. Cl. 707/620; 707/E17.005

(57) ABSTRACT

Disclosed herein is a data synchronization system which includes a plurality of electronic devices and a synchronization server. Each of the electronic devices includes a storage management module, an electronic device status module, and a synchronization module. The synchronization server, communicatively coupled to the electronic devices, includes an electronic device status management module and a data synchronization management module. Also disclosed herein are a data synchronization method and a computer readable storage medium having stored thereon a data synchronization program executable by the data synchronization system for synchronizing data.

### RELATED APPLICATIONS

This application claims priority to Taiwan Patent Application Serial Number 100142594, filed Nov. 21, 2011, which is herein incorporated by reference.

### BACKGROUND

1. Field of Invention

The embodiment of the present invention generally relates to data synchronization technique and, more particularly, to a data synchronization system operably to synchronize data among a plurality of electronic devices based on the volumes of the storages of the plurality of electronic devices, a data synchronization method for use in the data synchronization system, and a computer readable storage medium thereof.

2. Description of Related Art

Currently, available data synchronization techniques use a remote server device connected a plurality of electronic devices to form a data synchronization group. When a user performs an operation on any one electronic device within the data synchronization group, the data performed by the user for the operation would be synchronized to all electronic devices within the data synchronization group.

However, since each electronic device has its own characteristics, various issues may be invoked if all data are indiscriminatingly synchronized to every electronic device within the data synchronization group. For example, the data size may exceed the volume of some electronic devices and these devices could not accommodate the data, or the data format may not be executed by the software installed in the devices. Even more, some of the electronic devices may not need said data at all due to the duplication.

### SUMMARY

One intention of the present disclosure is to provide a data synchronization system, a data synchronization method for use in the data synchronization system, and a computer readable storage medium having stored thereon a data synchronization program executed by the data synchronization system for synchronizing data, so as to address one or more of the following issues: the data volume is too large to be stored in at least one electronic device within the data synchronization; the data format is incompatible with at least one electronic device so that the software stored in the electronic device could not execute the data; and the data is not required by at least one electronic device.

To this end, in one aspect, the present disclosure is related to a data synchronization system. The data synchronization system comprises a plurality of electronic devices and a synchronization server. The synchronization server is communicatively coupled to the plurality of electronic devices. Each of the plurality of electronic devices comprises a storage management module, an electronic device status module, and a synchronization module. The storage management module is operated to check the storage status in the electronic device, and generate a storage status information based on the check result. The electronic device status module is operated to transmit the storage status information and receive the storage status information from at least one other electronic device of the plurality of electronic devices. The synchronization module is operated to issue a synchronization request based on a synchronization setting information and the storage status information.

Furthermore, the synchronization server comprises an electronic device status management module and a data synchronization management module. The electronic device status management module is operated to receive the storage status information. The data synchronization management module is operated to receive the synchronization request, and synchronize the data between the electronic device and the at least one other electronic device in accordance with the synchronization request.

In view of the foregoing, another aspect of the present disclosure pertains to a data synchronization method. The data synchronization method is suitable for use in a data synchronization system. The data synchronization system comprises a plurality of electronic devices and a synchronization server. Each of the plurality of electronic devices comprises a storage management module, an electronic device status module and a synchronization module, and the synchronization server comprises an electronic device status management module and a data synchronization management module. The data synchronization method comprises the following steps: using the storage management module to check a storage status in each of the plurality of electronic devices, and generate a storage status information based on the check result; using the electronic device status module to transmit the storage status information and receive storage status information from at least one other electronic device of the plurality of electronic devices; using the synchronization module to issue a synchronization request based on a synchronization setting information and the storage status information; using the electronic device status management module to receive the storage status information; and using the data synchronization management module to receive the synchronization request, and synchronize the data between the electronic device and the at least one other electronic device in accordance with the synchronization request.

According to embodiments of the present disclosure, the term “volume” as used in the present system and method refers to either the available space of the storage or the total capacity of the storage of the electronic device.

According to other embodiments of the present disclosure, each of the plurality of electronic devices, as in the present disclosure system and method, further comprises a presentation module which is operated to present a user interface for configuring the synchronization setting information of a data.

According to still other embodiments of the present disclosure, the synchronization as described in the present disclosure system and method is further configured based on at least one synchronization condition rule. In these embodiments, the synchronization module is used to evaluate the electronic devices which is to be synchronized based on the at least one synchronization condition rule and the storage status information.

According to yet other embodiments of the system and method of the present disclosure, the data synchronization management module is used to store the synchronization request when the at least one other electronic device of the plurality of electronic devices is not communicatively coupled to the synchronization server. Further, when the at least one other electronic device of the plurality of electronic devices re-establishes the communication with the synchronization server, the data synchronization management module is used to synchronize the data between the electronic device and the at least one other electronic devices of the plurality of electronic devices in accordance with the synchronization request.

According to still other embodiments of the system and method of the present disclosure, each of the plurality of electronic devices further comprises a software management module which is used to check a plurality of softwares installed on the electronic device, and generate a software configuration information based on the check result. Further, each electronic device uses its electronic device status module to transmit the software configuration information and receive the software configuration information from at least one other electronic device; and uses its synchronization module to issue the synchronization request based on the synchronization setting information, the storage status information, and the software configuration information.

According to yet other embodiments of the system and method of the present disclosure, each of the plurality of electronic devices further comprises an alarm module which is used to generate an alarm signal in the case where the data to be synchronized from the electronic device to the at least one other electronic device could not be executed by the software installed correctly on the at least one other electronic device.

According to still other embodiments of the system and method of the present disclosure, each of the plurality of electronic devices maintains an information which describes the synchronized data and the corresponding electronic device which should be synchronized.

According to yet other embodiments of the system and method of the present disclosure, the information maintained by each electronic device further describes at least one data selected from the group consisting of size, modification time, data format, and data version of the data.

According to still other embodiments of the system and method of the present disclosure, each of the plurality of electronic devices further comprises an alarm module which is used to generate alarm signal when the data is to be synchronized from one electronic device of the plurality of electronic devices to another electronic device of the plurality of electronic devices and could not be synchronized by the another electronic device.

According to yet other embodiments of the system and method of the present disclosure, in the case where the storage status comprises an information related to the available space of the storage and the total capacity of the storage, the alarm module is used to generate an alarm signal when the size of the data to be synchronized exceeds the available space of the at least one other electronic device of the plurality of electronic devices.

According to still other embodiments of the system and method of the present disclosure, each of the plurality of electronic devices further comprises a device registration module, and the synchronization server further comprises a device registration management module. When the non-registered electronic device of the plurality of electronic devices is not registered to the synchronization server, the non-registered electronic device uses its device registration module to register to the device registration management module of the synchronization server.

In view of the foregoing, another aspect of the present disclosure provides a computer readable storage medium having stored thereon a computer program which is operated to perform the above-mentioned data synchronization method. Since the method steps are substantially the same as those described hereinabove, these steps are omitted herein for the sake of brevity.

Therefore, according to the technical features of the present invention, the embodiments of the present disclosure provide a data synchronization system, a data synchronization method for use in the data synchronization system, and computer readable storage medium having computer program for executing the data synchronization method, thereby allowing the user to acknowledge the hardware and/or software status of each electronic device via the data synchronization system, so that the user may adaptively select one or more suitable data to be synchronized between/among these electronic devices. In summary, embodiments of the present disclosure provide a convenient means for the user to accomplish the data synchronization.

Furthermore, by using the data synchronization system, data synchronization method, and computer readable storage medium according to embodiments of the present disclosure, it is possible to determine which one(s) of the electronic devices is/are to be synchronized with one data based on the volume specification of each electronic device. Moreover, it is possible to promptly inform the user whether there is enough available space of the electronic device to be synchronized for synchronizing the data, or to promptly inform the user that there is no suitable software for executing the data in the electronic device. Accordingly, the user may determine which one(s) of these electronic devices is to be synchronized with the data based on these information, which is convenient to the user. Also, the electronic device(s) would not have unnecessary data.

Moreover, by using a table according to embodiments of the present disclosure, it is possible for the user to adaptively select one or more suitable data to be synchronized in advanced based on various information of the data and the storage status information and software configuration information of the electronic device to be synchronized. In this way, the present embodiments facilitate the operation for users, and the operation is both time-effective and highly efficient.

### BRIEF DESCRIPTION OF THE DRAWINGS

The invention can be more fully understood by reading the following detailed description of the embodiments, with reference made to the accompanying drawings as follows:

FIG. 1 shows schematically a data synchronization system according to a first embodiment of the present disclosure;

FIG. 2 shows schematically a data synchronization system according to a second embodiment of the present disclosure;

FIG. 3 shows schematically a data synchronization system according to a third embodiment of the present disclosure;

FIG. 4 shows schematically a user interface of a data synchronization system according to another embodiment of the present disclosure;

FIG. 5 shows schematically a user interface of a data synchronization system according to yet another embodiment of the present disclosure;

FIG. 6 shows schematically a user interface of a data synchronization system according to still another embodiment of the present disclosure;

FIG. 7 shows schematically a user interface of a data synchronization system according to still another embodiment of the present disclosure;

FIG. 8 shows schematically a user interface of a data synchronization system according to yet another embodiment of the present disclosure;

FIG. 9 is a flow diagram illustrating a data synchronization method according to another embodiment of the present disclosure; and

FIG. 10 is a flow diagram illustrating a data synchronization method according to yet another embodiment of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail with reference to the drawings in which like reference numerals and designations in the various drawings are used to indicate like elements/parts. The use of embodiments and examples anywhere in this specification is illustrative only, and in no way limits the scope and meaning of the disclosure. Descriptions related to structural operations do not limit the order in which these operations take place. Any functionally-equivalent devices generated from structures obtained by re-combining the components are within the scope of the present disclosure.

The drawings are provided for illustration purpose. In accordance with common practice, the various described features/elements are not drawn to scale but instead are drawn to best illustrate specific features/elements relevant to the present invention. Also, descriptions of well-known components and processing techniques are omitted so as to not unnecessarily obscure the present invention.

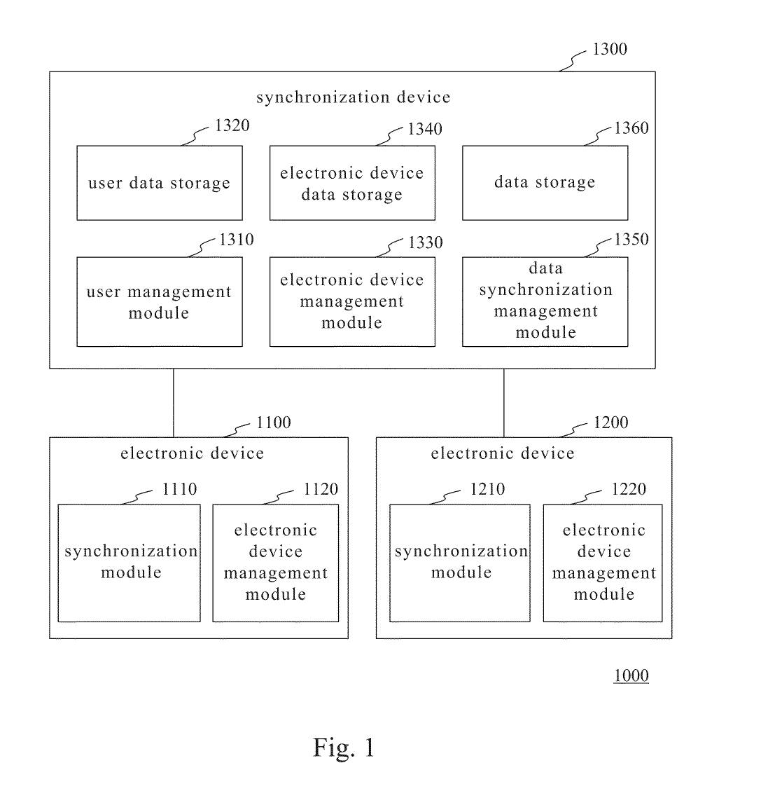

FIG. 1 is a schematic diagram of the data synchronization system 1000 illustrated in accordance with a first embodiment of the present disclosure. As shown in the figure, the data synchronization system 1000 comprises a plurality of electronic devices 1100 and 1200, and a synchronization server 1300. The synchronization server 1300 is communicatively coupled to the plurality of electronic devices 1100 and 1200.

In this embodiment, each of the plurality of electronic devices 1100 and 1200 comprises an electronic device management module (e.g., the electronic device management modules 1120 and 1220, each of which has an electronic device status update functionality and a storage management functionality) and a synchronization module (e.g., synchronization modules 1110 and 1210). The electronic device management module 1120 is operated to manage the hardware status of the electronic device 1100, check the storage status in the electronic device 1100, generate a storage status information based on the check result, transmit the thus-obtained storage status information to the synchronization server 1300, and receive the storage status information from other electronic device(s) (e.g., electronic device 1200). The synchronization module 1110 is operated to issue a synchronization request in accordance with the operation of a user and/or based on the storage status information of the electronic device 1200.

The synchronization server 1300 mainly comprises an electronic device management module 1330 and a data synchronization management module 1350. Furthermore, the synchronization server 1300 may further comprise a user management module 1310, a user data storage 1320, an electronic device data storage 1340, and data storage 1360. The user management module 1310 is operated to manage the user's account. The user data storage 1320 is operated to store the user data, such as the account name and password of the user account. The electronic device management module 1330 is operated to receive the hardware/software status data of the electronic device 1100, 1200 (such as the storage status information of electronic devices 1100 and 1200). The electronic device data storage 1340 is operated to store the hardware/software status data of the electronic device 1100, 1200 (such as the storage status information of electronic devices 1100 and 1200). The data synchronization management module 1350 is operated to receive the synchronization request, and synchronize the data to the electronic device to be synchronized in accordance with the synchronization request. The data storage 1360 is operated to store (or temporarily store) the meta-data of the data to be synchronized. For example, when the data to be synchronized is a file, the meta-data could be related to various versions of the file that is synchronized during a specified period of time. The user data storage 1320, the electronic device data storage 1340, and the data storage 1360 could be separate and independent storages or databases; alternatively, they could be stored in a single storage or integrated into a single database.

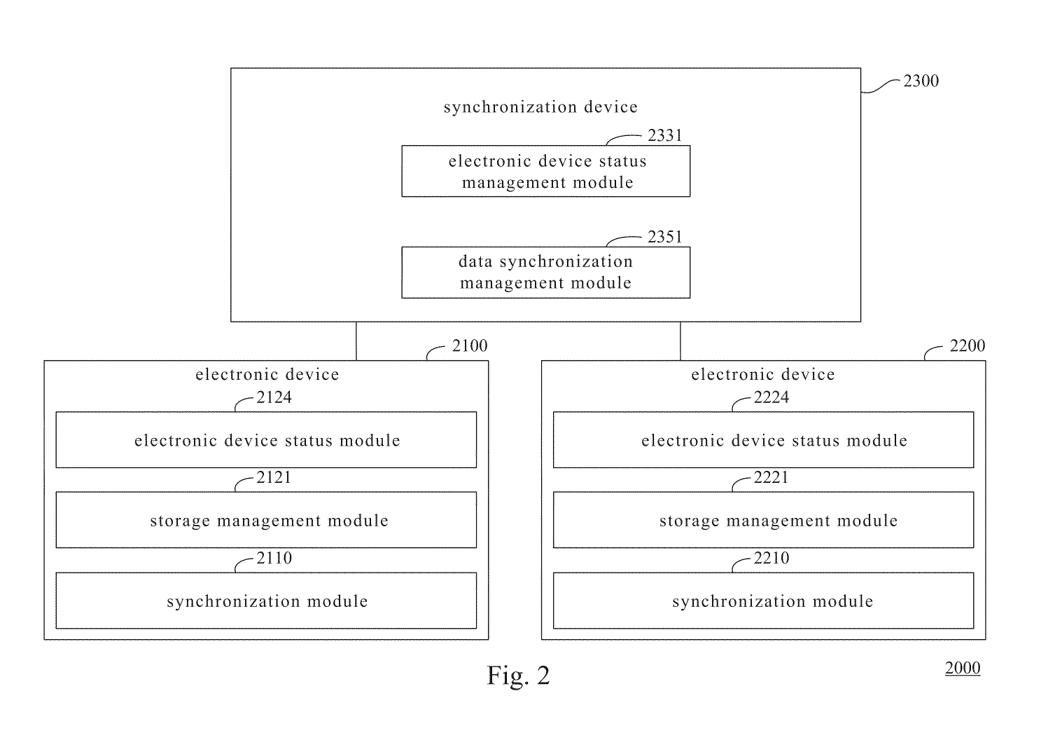

FIG. 2 is a schematic diagram of data synchronization system 2000 illustrated in accordance with a second embodiment of the present disclosure. Each of the electronic devices 2100 and 2200 of the data synchronization system 2000 comprises a storage management module 2121 or 2221, a synchronization module 2110 or 2210, and an electronic device status module 2124 or 2224. The synchronization server 2300 of the data synchronization system 2000 is communicatively coupled to the plurality of electronic devices 2100 and 2200. The synchronization server 2300 mainly comprises a data synchronization management module 2351 and an electronic device status management module 2331. It should be noted that same electronic components or modules depicted in FIG. 1 and FIG. 2 have the same name, and since the functionality of these electronic components or modules has been described in connection with FIG. 1, detailed descriptions thereof are omitted herein for brevity.

In operation, the storage management modules 2121 and 2221 are respectively operated to check the storage status in the electronic device, and generate a storage status information based on the check result. For example, the storage management modules 2121 and 2221 may acquire the respective storage status in the corresponding electronic device via the operating system (OS), and generate the storage status information based on the check result. The storage status information records the storage status in the corresponding electronic device. The storage status information may comprise information related to either the available space of the storage of the electronic device or the capacity specification of the storage (that is, the total capacity), or a combination of both.

Furthermore, the electronic device status modules 2124 and 2224 are each operated to transmit the storage status information and receive the storage status information from at least one other electronic device of the plurality of electronic devices. For example, the electronic device status module 2124 of the electronic device 2100 may transmit the storage status information acquired by the storage management module 2121 to the electronic device status module 2224 of the electronic device 2200. The synchronization modules 2110 and 2210 are each operated to issue a synchronization request based on a synchronization setting information and said storage status information. The synchronization setting information may be automatically generated by a synchronization setting module (not shown in FIG. 2) of the electronic device. Alternatively, a presentation module (not shown in FIG. 2) of the electronic device may present a user interface, so that the user may configure the synchronization setting information of the data.

Furthermore, the electronic device status management module 2331 of the synchronization server 2300 receives the storage status information transmitted from the electronic device status modules 2124 and 2224, and the data synchronization management module 2351 of the synchronization server 2300 receives the synchronization request from the electronic device 2100, and the data is synchronized to another electronic device (e.g., electronic device 2220) in accordance with the synchronization request.

For example, the electronic device status management module 2331 of the synchronization server 2300 is operated to receive the storage status information transmitted from the electronic device status modules 2124 and 2224, and the data synchronization management module 2351 of the synchronization server 2300 is operated to receive the synchronization requests generated by the synchronization modules 2110 and 2210. Since the storage status information of each electronic device of the data synchronization system has been transmitted to the synchronization server 2300 via the electronic device status modules 2124 and 2224, the electronic device 2100 may be aware of the storage status information of the electronic device 2200 via the synchronization server 2300.

Thereupon, the user may use the synchronization module 2110 of the electronic device 2100 to issue a synchronization request based on the storage status information of the electronic device 2200. The data synchronization management module 2351 of the synchronization server 2300 receives the synchronization request synchronize the data to the electronic device 2200 in accordance with the synchronization request.

In this way, the user may acknowledge the volume data of the storage of each electronic device via the data synchronization system 2000, and the user may adaptively select one or more suitable data to be synchronized between electronic devices thereby, which facilitate the data synchronization process.

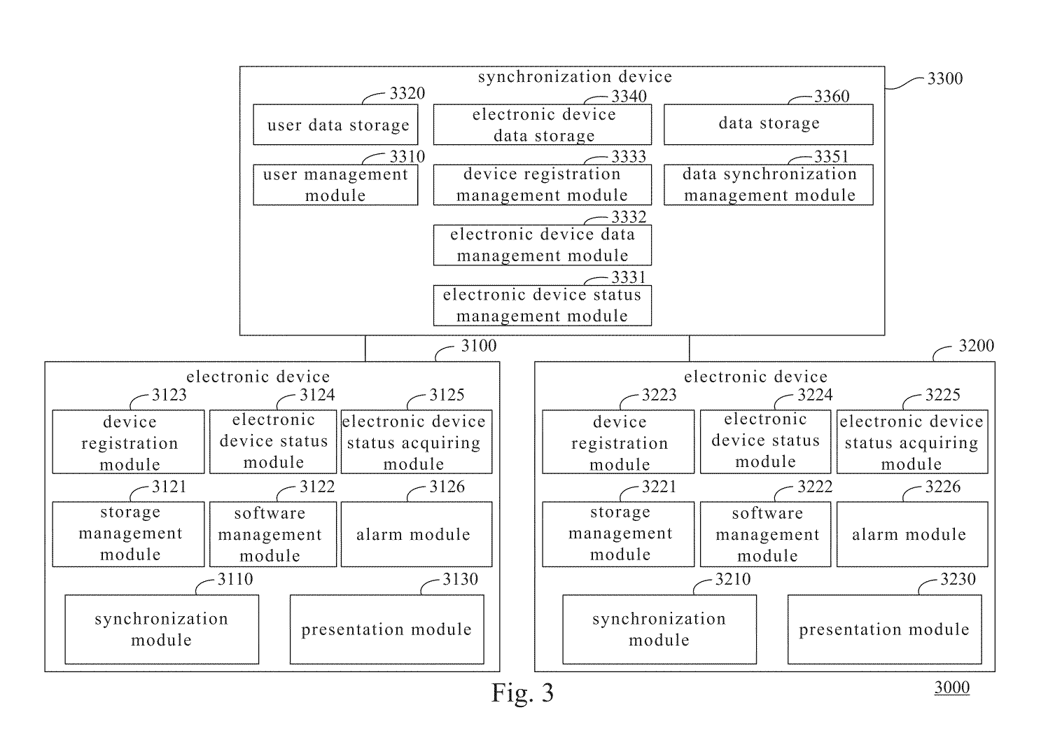

FIG. 3 is a schematic diagram of data synchronization system 3000 illustrated in accordance with a third embodiment of the present disclosure. It should be noted that same electronic components or modules depicted in FIG. 1, FIG. 2, and FIG. 3 have the same name, and since the functionality of these electronic components or modules has been described in connection with FIG. 1 and FIG. 2, detailed descriptions thereof are omitted herein for brevity.

As shown in FIG. 3, each electronic device further comprises a presentation module. The presentation module is operated to present a user interface for configuring the synchronization setting information of a data.

For example, the electronic device 3100 comprises a presentation module 3130 which is operated to generate a user interface so that the user may use the user interface to configure the synchronization setting information of a data. Furthermore, the user interface may be a graphical operation interface which is operated to display the graphical representation of the corresponding data and each of the plurality of electronic devices, and the synchronization setting information of the data may be configured by dragging the graphical representation of the data to at least one of the graphical representations of the plurality of electronic devices.

As described hereinabove, the synchronization is further configured based on at least one synchronization condition rule, and the synchronization module is further operated to evaluate the electronic devices which is to be synchronized based on the at least one synchronization condition rule and the storage status information.

For example, the synchronization is further configured based on at least one synchronization condition rule, and the synchronization module 3110 of the electronic device 3100 is further operated to evaluate the electronic devices which is to be synchronized based on the at least one synchronization condition rule and the storage status information. Furthermore, one of the at least one synchronization condition rule may be the rule for determining the at least one electronic device which would be synchronized based on one of such size, type, modification date, security level, attribute, setting permission and priority of the data.

In one embodiment, the data synchronization management module is further operated to store synchronization request when the at least one other electronic device of the plurality of electronic devices is not communicatively coupled to the synchronization server, and synchronize the data to said at least one other electronic device of the plurality of electronic devices in accordance with the synchronization request when the at least one other electronic device re-establishes the communication with the synchronization server.

For example, the data synchronization management module 3351 of the synchronization server 3300 is further operated to store synchronization request issued by the electronic device 3100 when the electronic device 3200 is not communicatively coupled to the synchronization server 3300, and the data synchronization management module 3351 of the synchronization server 3300 synchronizes the data to the electronic device 3200 in accordance with the synchronization request when the electronic device 3200 re-establishes the communication with the synchronization server 3300.

Referring to FIG. 3, each of the plurality of electronic devices further comprises a software management module which is operated to check the softwares installed on the electronic device, and generate a software configuration information based on the check result. The electronic device status module is further operated to transmit the software configuration information and receive the software configuration information from other electronic devices. The synchronization module described hereinabove is further operated to issue the synchronization request based on the synchronization setting information, the storage status information, and the software configuration information.

For example, the electronic device 3100 further comprises a software management module 3122 which is operated to check the softwares installed on the electronic device 3100 and generate a software configuration information based on the check result. The electronic device status module 3124 of the electronic device 3100 is further operated to transmit the software configuration information and receive the software configuration information from the electronic device 3200. The synchronization module 3110 of the electronic device 3100 is further operated to issue the synchronization request based on the synchronization setting information, the storage status information, and the software configuration information.

In another embodiment, each of the plurality of electronic devices further comprises an alarm module. When the data is being synchronized from one electronic device to the at least one other electronic device, and said the other electronic device fails to synchronize the data, the alarm module would generate an alarm signal.

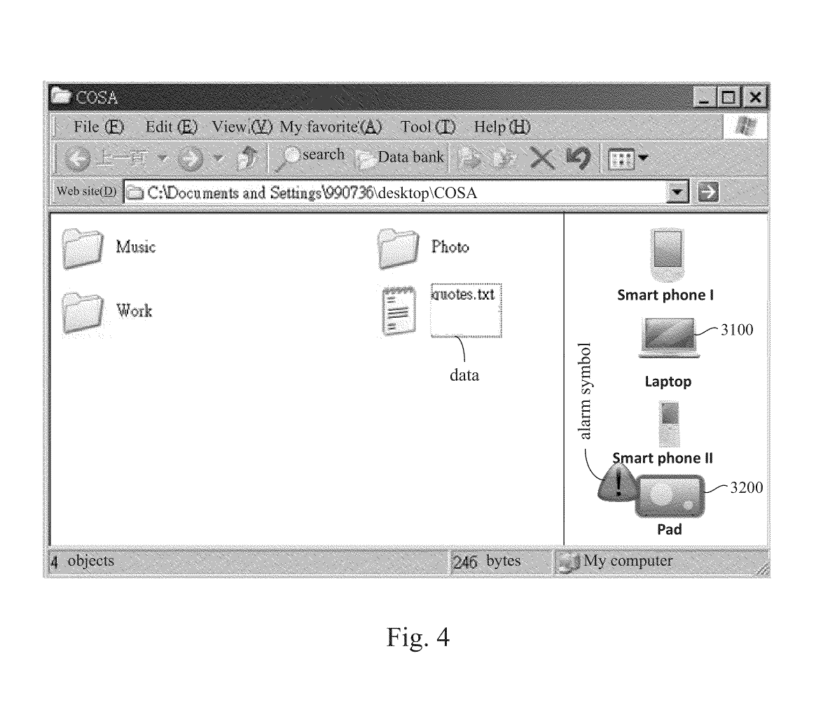

For example, when the data is being synchronized from the electronic device 3100 to the electronic device 3200 and the electronic device 3200 fails to synchronize the data, the alarm module 3126 of the electronic device 3100 would generate an alarm signal as depicted in FIG. 4. FIG. 4 is a schematic diagram illustrating a user interface of the data synchronization system 3000 according to another embodiment of the present disclosure. When the volume of the electronic device 3200 is sufficient to accommodate the data, the data is synchronized to the electronic device 3200 via the synchronization server 3300. It should be noted that the Smart phone I, Laptop, Smart phone II, and Pad depicted in FIG. 4 are only illustrative examples of various electronic device (for example, the Laptop may serve as the electronic device 3100, and the Pad may serve as the electronic device 3200), and shall not be construed as a limitation to the present disclosure.

Attention is now directed to situations where the synchronization between electronic devices could not be accomplished. First, it should be noted that the term “volume” as used herein refers to either the available space of the storage or the total capacity. Accordingly, when a data is to be synchronized from the electronic device 3100 to the electronic device 3200 and the size of the data from the electronic device 3100 exceeds the available space of the electronic device 3200, the alarm module 3126 of the electronic device 3100 would generate an alarm signal. Furthermore, when the available space of the electronic device is sufficient to accommodate the data, the data is synchronized to the electronic device 3200 via the synchronization server 3100.

In this way, the user may be promptly aware that whether or not is there sufficient volume of the electronic device 3200 to accommodate the data. Accordingly, the user may choose to abort the synchronization of the data to electronic device 3200, or to make room for the data to be synchronized by removing/deleting existing data stored on the electronic device 3200, thereby facilitating the users in using the data synchronization system 3000 according to the present disclosure embodiment.

In another situation, when a data is to be synchronized from the electronic device 3100 to the electronic device 3200, if all the softwares installed on the electronic device 3200 could not execute the data, the alarm module 3126 of the electronic device 3100 would generate the alarm signal as shown in FIG. 4.

In this way, the user may be promptly aware that there is no suitable software installed on the electronic device 3200 capable of executing the data. Accordingly, the user may choose to abort the synchronization of the data to electronic device 3200, or to install a corresponding software on the electronic device 3200 for executing the data to be synchronized, thereby facilitating the users in using the data synchronization system 3000 according to the present disclosure embodiment. Also, there would be no unnecessary data stored on the electronic device 3200.

Referring to FIG. 3, each of the plurality of electronic devices further comprises a device registration module, and the synchronization server further comprises a device registration management module. When a non-registered electronic device of the plurality of electronic devices is not registered to the synchronization server, it may use a device registration module to register to the device registration management module of the synchronization server.

For example, when the electronic device 3100 is not registered to the synchronization server 3000, the electronic device 3100 is a new device to the server 3300. If the user wishes to incorporate the electronic device 3100 into the data synchronization system, he should use the device registration module 3123 of the electronic device 3100 to register to the device registration management module 3333 of the synchronization server 3300. Thereafter, the user may handle the electronic device 3100 through the data synchronization system 3000. In other words, only registered electronic devices are operated to transmit the storage status information and receive the storage status information from at least one other electronic device of the plurality of electronic devices via the electronic device status module, and the data synchronization system 3000 shall only handle the registered electronic device under the condition that the storage status information of the registered electronic device is known.

In one embodiment, each of the plurality of electronic devices further comprises an electronic device status acquiring module (3125 or 3225), each of the electronic device status acquiring modules 3125 and 3225 is operated to acquire storage status information and software configuration information from the electronic device status management module 3331 of the synchronization server 3300, and transmit the storage status information and software configuration information to the electronic device status modules 3124 and 3224.

The user data storage 3320 is operated to store the user data, such as the account name and password of the user account. The electronic device data storage 3340 is operated to store the hardware/software status data (e.g., the storage status information and software configuration information of the electronic devices 3100 and 3200) of the electronic device. The data synchronization management module 3351 is operated to receive the synchronization request and synchronize the data to the other electronic device to be synchronized in accordance with the synchronization request. The data storage 3360 is operated to store (or temporarily store) the data of the data to be synchronized; for example, when the data to be synchronized is a file, the data could be various versions of the file that is synchronized during a specified period of time. The user data storage 3320, the electronic device data storage 3340, and the data storage 3360 could be separate and independent storages or databases; alternatively, they could be stored in a single storage or integrated into a single database.

In this way, the user may acquire data associated with the other electronic device(s) through any one electronic device of the plurality of electronic devices, thereby facilitating the users to perform the data synchronization between/among the plurality of electronic devices. In these embodiments, the electronic device data management module 3332 of the synchronization server 3300 is operated to store the more constant data of the plurality of electronic devices; these constant data could be, such as, the model number of the central processing unit, the volume of the flash memory, etc.

In one embodiment, each of the plurality of electronic devices maintains an information as to the synchronized data and the corresponding electronic device which should be synchronized, as well as the above-mentioned data.

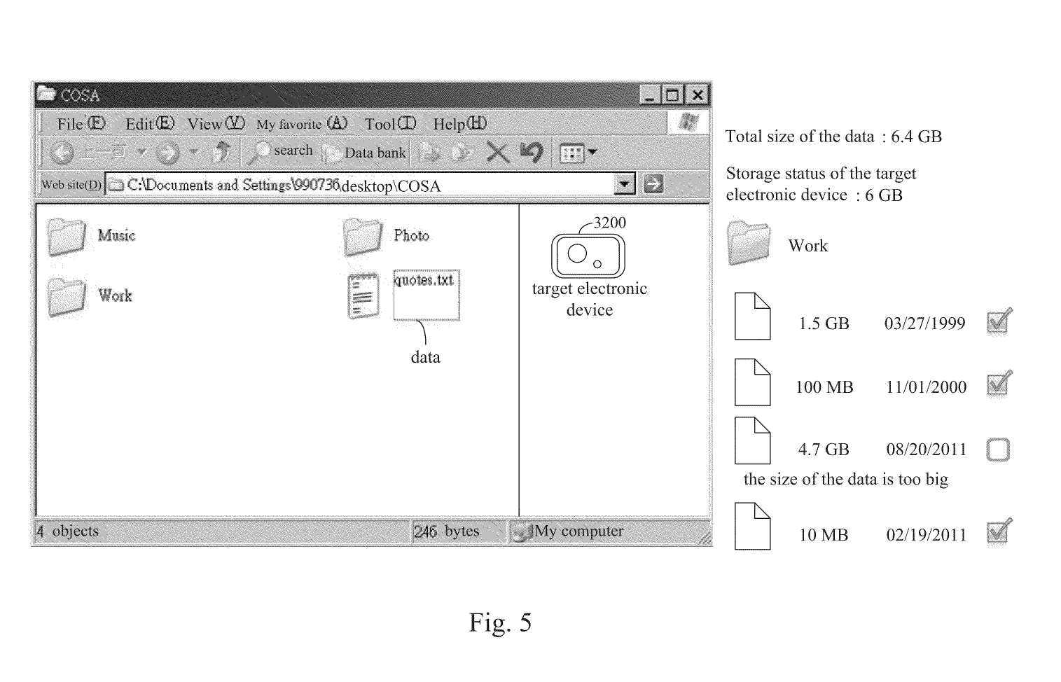

For example, the electronic device 3100 comprises the tables illustrated in FIGS. 5 to 8 (right panel). FIGS. 5 to 8 are schematic diagrams illustrating the user interface of the data synchronization system 3000 according to yet another embodiment of the present disclosure, in which the user interface is generated by the presentation module depicted in FIG. 3, and the above-mentioned information is presented in the form of a table. For example, each table presents the information as to the synchronized data and the corresponding electronic device which should be synchronized, as well as the above-mentioned data. For example, when a data is designated to be synchronized from the electronic device 3100 to the electronic device 3200, this operation would be recorded in the table. Furthermore, the electronic device 3100 may select at least one of the information maintained in the table based on said data and based on the storage status information and software configuration information of the electronic device 3200, so that the selected data is synchronized to the electronic device 3200 via the synchronization server 3300. According to the present embodiment, the target electronic device depicted in FIGS. 5 to 8 is the electronic device 3200.

In one embodiment, the data comprises at least one of size, creation time, format, and version of the data to be synchronized. Attention is first directed to the embodiment depicted in FIG. 5, in which the selection is performed based on the data size and the volume data of the electronic device 3200. As shown in FIG. 5, the volume of the electronic device 3200 is 6 GB, and the total data size of all the data to be synchronized from the electronic device 3100 to the electronic device 3200 is 6.4 GB. Accordingly, the electronic device 3100 would de-select the data having a size of 4.7 GB, and select the remaining data to proceed to the synchronization. As described hereinabove, in this embodiment, the target electronic device depicted in FIG. 5 is the electronic device 3200.

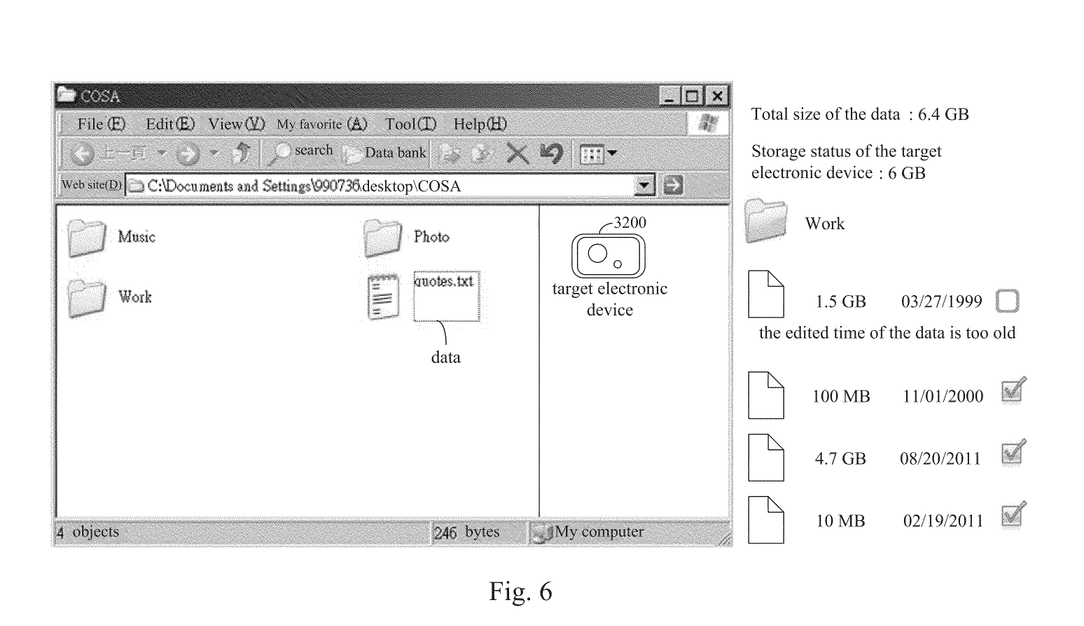

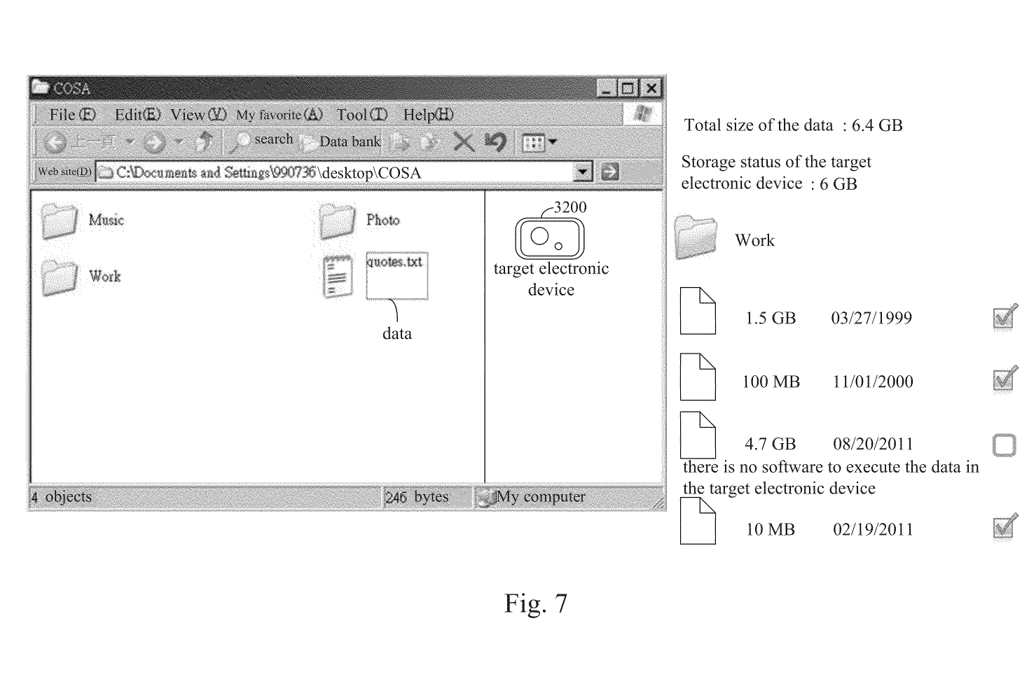

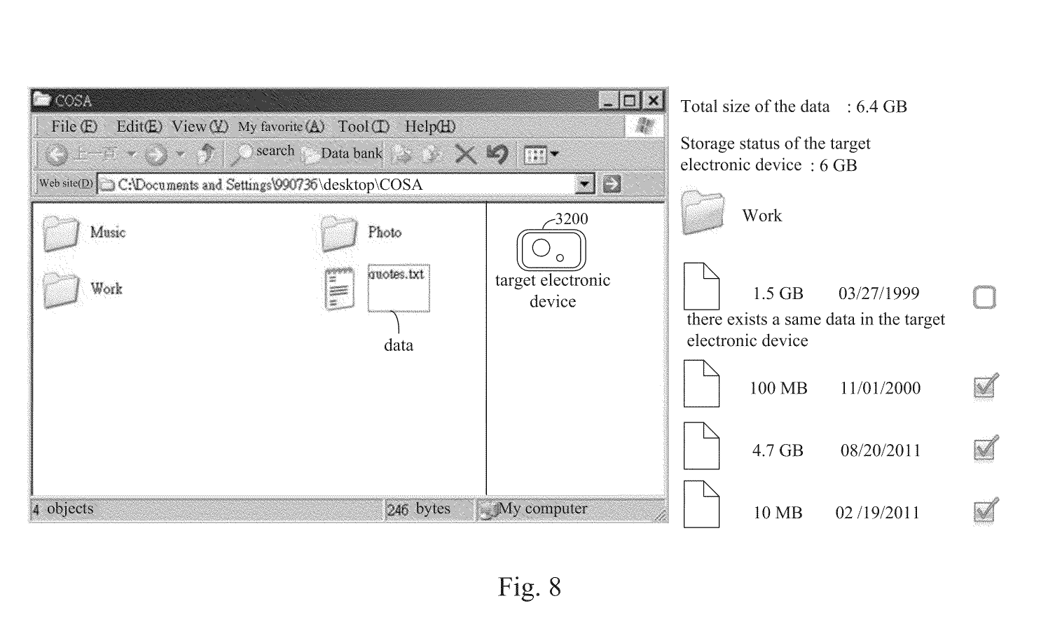

Attention is next directed to the embodiment depicted in FIG. 6, in which the selection is performed based on the modification time of the data. As shown in FIG. 6, since the 1.5 GB data stored on electronic device 3100 is last edited at a more distant time, this 1.5 GB data would be excluded, and the remaining data would proceed to the synchronization. Referring to the embodiment depicted in FIG. 7, in which the selection is performed based on the data format and based on the software configuration information of the electronic device 3200. In this example, since the softwares installed on the electronic device 3200 could not execute the 4.7 GB data to be synchronized from the electronic device 3100, the electronic device 3100 would de-select the 4.7 GB data in the table, and select the remaining data to proceed to the synchronization. Next, in the embodiment depicted in FIG. 8, the selection is performed based on the version of the data to be synchronized. In this case, since the electronic device 3200 already has a data which is the same as the 1.5 GB data to be synchronized from the electronic device 3100, the electronic device 3100 would de-select the 1.5 GB data in the table, and select the remaining data to proceed to the synchronization. As could be appreciated, in these embodiments, the target electronic device depicted in FIGS. 6 to 8 is the electronic device 3200.

In view of the foregoing description in connection with FIGS. 5 to 8, the table stored on the electronic device 3100 may adaptively select suitable data to be synchronized in advanced based on various data of the data and the storage status information and software configuration information (e.g., volume) of the electronic device 3200. In this way, the present embodiments facilitate the operation for users, and the operation is both time-effective and highly efficient.

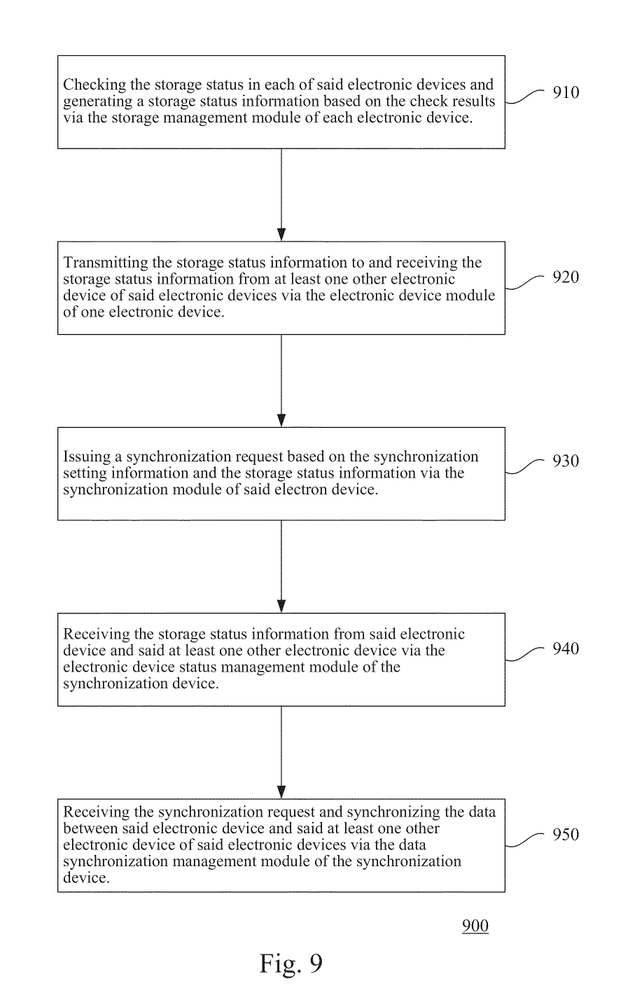

FIG. 9 is a flow chart depicting a data synchronization method 900 according to another embodiment of the present disclosure. The data synchronization method 900 is used in the present data synchronization system; the data synchronization system comprises a plurality of electronic devices and synchronization server, each of the plurality of electronic devices comprises a storage management module, an electronic device status module, and a synchronization module and the synchronization server comprises an electronic device status management module and a data synchronization management module. The data synchronization method comprises the following steps: using the storage management module to check a storage status in each of the plurality of electronic devices, and generate a storage status information based on the check result (step 910); using the electronic device status module to transmit the storage status information and receive the storage status information from at least one other electronic device of the plurality of electronic devices (step 920); using the synchronization module to issue a synchronization request based on the a synchronization setting information and the storage status information (step 930); using the electronic device status management module to receive the storage status information (step 940); and using the data synchronization management module to receive the synchronization request, and synchronize the data to at least one other electronic device of the plurality of electronic devices in accordance with the synchronization request (step 950).

Referring to both FIG. 2 and FIG. 9. In step 910, for example, the storage management module 2121 or 2221 is used to acquire the storage status in corresponding electronic devices via the operation system, and is used to generate a storage status information based on the check result; said storage status information records the storage status (e.g., volume) in the corresponding electronic devices.

Next, in step 920, the electronic device status module 2124 of the electronic device 2100 is used to transmit the storage status information and receive the storage status information from the electronic device 2200; whereas in step 930, the synchronization module 2110 of the electronic device 2100 is used to issue a synchronization request based on the synchronization setting information and the storage status information.

Next, in step 940, the electronic device status management module 2331 of the synchronization server 2300 is used to receive storage status information transmitted from the electronic device status module 2124 of the electronic device 2100 and the electronic device status module 2224 of the electronic device 2200. In step 950, the data synchronization management module 2351 of the synchronization server 2300 is operated to receive the synchronization request issued by the synchronization module 2110 of the electronic device 2100, and is used to synchronize data to the electronic device 2200 in accordance with the synchronization request.

In this way, the user may be aware of the hardware/software status of each electronic device by using the data synchronization method 900, and thereby, the user may adaptively select the suitable data to be synchronized between/among electronic devices. In this way, the present embodiments facilitate the data synchronization operation for users, and the operation is both time-effective and highly efficient.

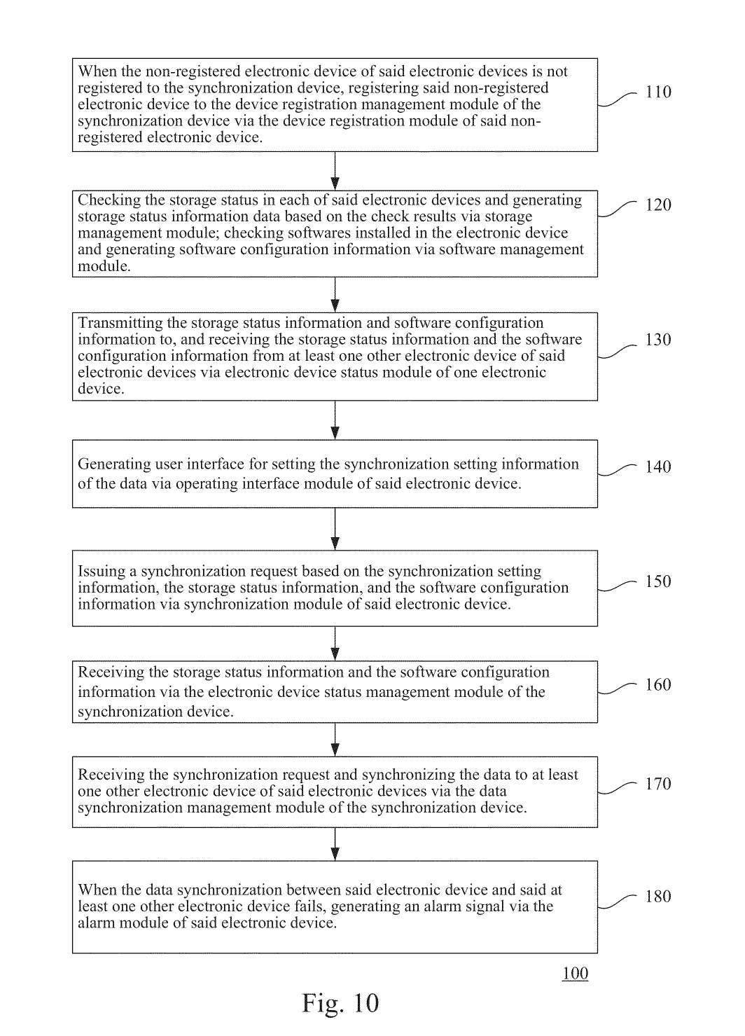

FIG. 10 is a flow chart depicting a data synchronization method 1000 according to yet another embodiment of the present disclosure. The data synchronization method 100 is used in the present data synchronization system; the data synchronization system comprises a plurality of electronic devices and synchronization server. The electronic components of the plurality of electronic devices and the synchronization server have been discussed in connection with FIG. 3, and hence are omitted herein for the sake of brevity. The data synchronization method 900 comprises the following steps: using the device registration module of the non-registered electronic device of the plurality of electronic devices to register to the device registration management module of the synchronization server, when a non-registered electronic device of the plurality of electronic devices is not registered to the synchronization server (step 110); using the storage management module to check a storage status in each of the plurality of electronic devices, and generate a storage status information based on the check result, using the software management module to check each software installed on the electronic device, and generate a software configuration information based on the check result (step 120); using the electronic device status module to transmit the storage status information and software configuration information, and to receive the storage status information and software configuration information from at least one other electronic device of the plurality of electronic devices (step 130); and using the presentation module to generate a user interface for configuring the synchronization setting information of the data (step 140).

Referring to both FIG. 3 and FIG. 10. In step 110, for example, when the electronic device 3100 has not registered to the synchronization server 3300, the electronic device 3100 is a new device to the synchronization server 3300, and if the user wants to add the electronic device 3100 into the data synchronization system, the user shall use the device registration module of the electronic device 3100 to register to the device registration management module of the synchronization server 3300. Thereafter, the user may perform the operation to the electronic device 3100 via the data synchronization system. In other words, only registered electronic devices are operated to transmit the storage status information and receive the storage status information from at least one other electronic device of the plurality of electronic devices via the electronic device status module, and the data synchronization system 3000 shall only handle the registered electronic device under the condition that the storage status information of the registered electronic device is known.

In contrast to step 920 depicted in FIG. 9, the step 120 further comprises the process of using the software management module to check each software installed on the electronic device, and a generate software configuration information based on the check result. For example, the software management module 3122 is used to check a plurality of softwares installed on the electronic device 3100, and generate the software configuration information based on the check result.

Furthermore, in contrast to step 930 of FIG. 9, step 130 further comprises the process of using the electronic device status module to transmit the software configuration information and receive the software configuration information from at least one other electronic device of the plurality of electronic devices. For example, the electronic device status module 3124 of the electronic device 3100 is used to transmit the software configuration information and receive the software configuration information from the electronic device 3200.

In step 140, for example, the presentation module 3130 of the electronic device 3100 is used to generate a user interface for configuring the synchronization setting information of a data. Furthermore, the user interface may be a graphical operation interface which is operated to display the graphical representation of the corresponding data and each of the plurality of electronic devices, and the synchronization setting information of the data may be configured by dragging the graphical representation of the data to at least one of the graphical representations of the plurality of electronic devices. Detailed discussion regarding the user interface is provided hereinabove in connection with FIG. 4.

In the present embodiment, the synchronization is further configured based on at least one synchronization condition rule, and the data synchronization method 100 further comprises using the synchronization module to evaluate the electronic devices which is to be synchronized based on the at least one synchronization condition rule and the storage status information.

For example, the data synchronization method 100 may use the synchronization module 3110 of the electronic device 3100 to evaluate the electronic device which is to be synchronized based on at least one synchronization condition rule and the storage status information. Furthermore, the at least one synchronization condition rule may evaluate the electronic device to be synchronized based on a variety of data, such as size, type, modification date, security level, attribute, setting permission and priority of the data to be synchronized.

As shown in FIG. 10, the data synchronization method further comprises the following steps: using the synchronization module to issue a synchronization request based on the synchronization setting information, the storage status information and the software configuration information (step 150); using the electronic device status management module to receive the storage status information and the software configuration information (step 160); using the data synchronization management module to receive the synchronization request, and synchronize the data to at least one other electronic device of the plurality of electronic devices in accordance with the synchronization request (step 170); and using the alarm module to generate an alarm signal when the data is to be synchronized from one electronic device of the plurality of electronic devices to another electronic device of the plurality of electronic devices, and the another electronic device could not synchronize the data (step 180).

In contrast to step 930 of FIG. 9, the step 150 further comprises using the synchronization module to issue a synchronization request based on the synchronization setting information, the storage status information, and the software configuration information. For example, the synchronization module 3110 of the electronic device 3100 may be used to issue a synchronization request based on the synchronization setting information, the storage status information, and the software configuration information.

In step 160, the electronic device status management module is used to receive the storage status information and the software configuration information. In contrast to step 940 of FIG. 9, step 160 further comprises using the electronic device status management module to receive software configuration information. For example, the electronic device status management module 3331 of the synchronization server 3300 could be used to receive software configuration information.

In step 170, for example, the data synchronization management module 3351 of the synchronization server 3300 is used to receive the synchronization request issued by the synchronization module 3110 of the electronic device 3100, and synchronize the data to the electronic device 3200 in accordance with the synchronization request.

Specifically, when the electronic device 3200 is not communicatively coupled to the synchronization server 3300, the data synchronization management module 3351 of the synchronization server 3300 is used to store the synchronization request issued by the synchronization module 3110 of the electronic device 310; and when the electronic device 3200 re-establishes the communication with the synchronization server 3300, the data synchronization management module 3351 is used to synchronize the data to the electronic device 3200 in accordance with the synchronization request.

In step 180, for example, when the data is to be synchronized from the electronic device 3100 to the electronic device 3200, and the electronic device 3200 could not synchronize the data, the alarm module 3126 of the electronic device 3100 is used to generate the alarm signal as depicted in FIG. 4.

Attention is now directed to situations where the synchronization between electronic devices could not be accomplished. First, it should be noted that the term “volume” as used herein refers to either the available space of the storage or the total capacity. Accordingly, when a data is to be synchronized from the electronic device 3100 to the electronic device 3200, if the size of the data from the electronic device 3100 exceeds the available space of the electronic device 3200, the alarm module 3126 of the electronic device 3100 would generate an alarm signal. Furthermore, when the available space of the electronic device is sufficient to accommodate the data, the data synchronized to the electronic device 3200 via the synchronization server 3100. In this way, the user may be promptly aware that whether or not there is sufficient volume of the electronic device 3200 to accommodate the data. Accordingly, the user may choose to abort the synchronization of the data to electronic device 3200, or to make room for the data to be synchronized by removing/deleting existing data stored on the electronic device 3200, thereby facilitating the users in using the data synchronization system 3000 according to the present disclosure embodiment.

In another situation, when a data is to be synchronized from the electronic device 3100 to the electronic device 3200, if all the softwares installed on the electronic device 3200 could not execute the data, the alarm module 3126 of the electronic device 3100 would generate the alarm signal.

In this way, the user may be promptly aware that there is no suitable software installed on the electronic device 3200 capable of executing the data. Accordingly, the user may choose to abort the synchronization of the data to electronic device 3200, or to install a corresponding software on the electronic device 3200 for executing the data on, thereby facilitating the users in using the data synchronization system 3000 according to the present disclosure embodiment. Also, there would be no unnecessary data stored on the electronic device 3200.

Furthermore, each of the plurality of electronic devices maintains an information which describes the synchronized data and the corresponding electronic device which should be synchronized. The data synchronization method 100 further comprises using the information to record the above-mentioned information as to which one of the data has been synchronized to which one(s) of the plurality of electronic devices, as well as the data of the data to be synchronized.

For example, the electronic device 3100 maintains said information in the form of the tables as shown in FIGS. 5 to 8 (right panel), and these tables record said data as well as information as to which one of the data has been synchronized to which one(s) of the plurality of electronic devices. For example, when a data is designated to be synchronized from the electronic device 3100 to the electronic device 3200, this operation would be recorded in the table. Furthermore, the electronic device 3100 is used to select at least one of the data present in the table, in which the selected data is to be synchronized to electronic device 3200 via the synchronization server 3300. This selection is based on said data and based on the storage status information and software configuration information of the electronic device 3200. The operation status has been discussed in connection with FIGS. 5 to 8, and hence is omitted herein for the sake of brevity.

Those having skill in the art will appreciate that the data synchronization method 900, 100 can be performed with software, hardware, and/or firmware. For example, if an implementer determines that speed and accuracy are paramount, the implementer may opt for a mainly hardware and/or firmware implementation; alternatively, if flexibility is paramount, the implementer may opt for a mainly software implementation; or, yet again alternatively, the implementer may opt for some combination of hardware, software, and/or firmware. Those skilled in the art will recognize that optical aspects of implementations will typically employ optically oriented hardware, software, and or firmware.

In addition, those skilled in the art will appreciate that each of the steps of the data synchronization method 900, 100 named after the function thereof is merely used to describe the technology in the embodiment of the present invention in detail rather than limiting the present invention. Therefore, combining the steps of said method into one step, dividing the steps into several steps, or rearranging the order of the steps is within the scope of the embodiment in the present invention.

The data synchronization methods 900 and 100 may take the form of a computer program product stored on a computer-readable storage medium such that the data synchronization method can be implemented after the storage medium is read by the computer. The computer-readable storage medium can be a read only memory (ROM), a flash memory, a floppy disk drive, a hard disk drives (HDD), a compact disk (CD), a USB disk, a magnetic tape, a database which can be read and accessed via Network, or any computer-readable storage medium which can be adopted by those skilled in the art and which has the same functionality. The data synchronization methods 900 and 100 can be implemented by integrating the computer program and more than one processor and chip.

In view of the foregoing embodiments of the present disclosure, it is contemplated that the present disclosure has the advantages as follows. Embodiments of the present disclosure provide a data synchronization system, a data synchronization method for use in the data synchronization system, and a computer readable storage medium having stored thereon a computer program executable by the data synchronization system to perform the data synchronization method; these embodiments allow the user to be aware of the hardware and/or software status of each electronic device via the data synchronization system, so that the user may adaptively select one or more suitable data to be synchronized between/among these electronic devices. In summary, embodiments of the present disclosure provide a convenient means for the user to accomplish the data synchronization.

Furthermore, by using the data synchronization system, data synchronization method, and computer readable storage medium according to embodiments of the present disclosure, it is possible to promptly inform the user whether there is sufficient available space of the electronic device to be synchronized for synchronizing the data, or to promptly inform the user that there is no suitable software for executing the data in the electronic device. Accordingly, the user may evaluate which one of these electronic devices is to be synchronized with the data based on these information; this process is convenient to the user. Also, the electronic device(s) would not have unnecessary data.

Moreover, by using the table according to embodiments of the present disclosure, it is possible for the user to adaptively select suitable data to be synchronized in advanced based on various data of the data and the storage status information and software configuration information of the electronic device to be synchronized. In this way, the present embodiments facilitate the operation for users, and the operation is both time-effective and highly efficient.

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

1. A data synchronization system, comprising:
a plurality of electronic devices, wherein each of the plurality electronic devices comprises:
a storage management module operated to check a storage capacity in the electronic device, and generate a storage capacity information based on the check result;
an electronic device status module operated to transmit the storage capacity information and receive the storage capacity information from at least one other electronic device of the plurality of electronic devices; and
a synchronization module operated to issue a synchronization request based on a synchronization setting information and the storage capacity information; and
a synchronization server, communicatively coupled to the plurality of electronic devices, wherein the synchronization server comprises:
an electronic device status management module operated to receive the storage capacity information; and
data synchronization management module operated to receive the synchronization request, and synchronize the data to at least one other electronic device of the plurality of electronic devices in accordance with the synchronization request.

2. The data synchronization system of the claim 1, wherein the storage capacity comprises an information which is one of the available space of the storage and the total capacity of the storage.

3. The data synchronization system of the claim 1, wherein each of the plurality of electronic devices further comprises a presentation module operated to present a user interface for configuring the synchronization setting information of the data.

4. The data synchronization system of the claim 1, wherein the synchronization is further configured based on at least one synchronization condition rule, and the synchronization module is further operated to evaluate the electronic device which is to be synchronized based on the at least one synchronization condition rule and the storage capacity information of the electronic device.

5. The data synchronization system of the claim 1, wherein the data synchronization management module is further operated to store the synchronization request when the at least one other electronic device of the plurality of electronic devices is not communicatively coupled to the synchronization server, and synchronize the data to the at least one other electronic device of the plurality of electronic devices when the at least one other electronic device of the plurality of electronic devices re-establishes the communication with the synchronization server.

6. The data synchronization system of the claim 1, wherein each of the plurality of electronic devices further comprises a software management module operated to check a plurality of software installed on the electronic device, and generate a software configuration information based on the check result,
wherein the electronic device status module is further operated to transmit the software configuration information and receive the software configuration information from other electronic devices, and the synchronization module is further operated to generate the synchronization request based on the synchronization setting information, the storage capacity information, and the software configuration information.

7. The data synchronization system of the claim 6, wherein each of the plurality of electronic devices further comprises an alarm module operated to generate an alarm signal when the data to be synchronized from one electronic device of the plurality of electronic devices to another electronic device of the plurality of electronic devices could not be executed correctly by the software installed on the another electronic device.

8. The data synchronization system of the claim 1, wherein each of the plurality of electronic devices maintains an information which describes the synchronized data and the corresponding electronic device which should be synchronized.

9. The data synchronization system of the claim 8, wherein the information further describes at least one data selected from the group consisting of size, modification time, data format, and data version of the data.

10. The data synchronization system of the claim 2, wherein each of the plurality of electronic devices further comprises an alarm module operated to generate an alarm signal when the data is to be synchronized from one electronic device of the plurality of electronic devices to another electronic device of the plurality of electronic devices and could not be synchronized by the another electronic device.

11. The data synchronization system of the claim 10, wherein the storage capacity comprises the information of the available space of the storage, and the alarm module is further operated to generate the alarm signal when the size of the data to be synchronized exceeds the available space of the another electronic device of the plurality of electronic devices.

12. The data synchronization system of the claim 1, wherein each of the plurality of electronic devices further comprises a device registration module, and the synchronization server further comprises a device registration management module, and when a non-registered electronic device of the plurality of electronic devices is not registered to the synchronization server, the non-registered electronic device of the plurality of electronic devices uses its device registration module to register to the device registration management module of the synchronization server.

13. A data synchronization method for use in a data synchronization system, the data synchronization system comprises a plurality of electronic devices and a synchronization server, each of the plurality of electronic devices comprises a storage management module and an electronic device status module, and the synchronization server comprises an electronic device status management module and an data synchronization management module, wherein the data synchronization method comprises:
using the storage management module to check a storage capacity in the electronic device, and generate a storage capacity information based on the check result;
using the electronic device status module to transmit the storage capacity information and receive the storage capacity information from at least one other electronic device of the plurality of electronic devices;
using the synchronization module to issue a synchronization request based on a synchronization setting information and the storage capacity information;
using the electronic device status management module to receive the storage capacity information; and
using the data synchronization management module to receive the synchronization request, and synchronize the data to at least one other electronic device of the plurality of electronic devices in accordance with the synchronization request.

14. The data synchronization method of the claim 13, wherein the synchronization is further configured based on at least one synchronization condition rule, and the data synchronization method further comprises:
using the synchronization module to evaluate the electronic device which is to be synchronized based on the at least one synchronization condition rule and the storage capacity information of the electronic device.

15. The data synchronization method of the claim 13, further comprising:
using the data synchronization management module to store the synchronization request when the at least one other electronic device of the plurality of electronic devices is not communicatively coupled to the synchronization server, and synchronize the data to the at least one other electronic device of the plurality of electronic devices when the at least one other electronic device of the plurality of electronic devices re-establishes the communication with the synchronization server.

16. The data synchronization method of the claim 13, wherein each of the plurality of electronic devices further comprises a software management module, wherein the data synchronization method further comprises:
using the software management module check a plurality of software installed on the electronic device, and generate a software configuration information based on the check result;
using the electronic device status module to transmit the software configuration information and receive the software configuration information from other electronic devices; and
using the synchronization module to issue the synchronization request based on the synchronization setting information, the storage capacity information, and the software configuration information.

17. The data synchronization method of the claim 16, wherein each of the plurality of electronic devices further comprises an alarm module, wherein the data synchronization method further comprises:
using the alarm module to generate an alarm signal when the data to be synchronized from one electronic device of the plurality of electronic devices to another electronic device of the plurality of electronic devices could not be executed correctly by the software installed on the another electronic device.

18. The data synchronization method of the claim 13, wherein each of the plurality of electronic devices further comprises an alarm module, wherein the data synchronization method further comprises:
using the alarm module to generate an alarm signal when the data is to be synchronized from one electronic device of the plurality of electronic devices to another electronic device of the plurality of electronic devices and could not be synchronized by the another electronic device.

19. The data synchronization method of the claim 13, wherein each of the plurality of electronic devices further comprises a device registration module, and the synchronization server further comprises a device registration management module, wherein the data synchronization method further comprises:
when a non-registered electronic device of the plurality of electronic devices is not registered to the synchronization server, use the device registration module of the non-registered electronic device of the plurality of electronic devices to register to the device registration management module of the synchronization server.

20. A non-transitory computer readable storage medium having stored thereon a computer program executable to perform a data synchronization method, in which the data synchronization method is used in a data synchronization system, the data synchronization system comprises a plurality of electronic devices and a synchronization server, each of the plurality of electronic devices comprises a storage management module and an electronic device status module, and the synchronization server comprises an electronic device status management module and an data synchronization management module, wherein the data synchronization method comprises:
using the storage management module to check a storage capacity in the electronic device, and generate a storage capacity information based on the check result;
using the electronic device status module to transmit the storage capacity information and receive the storage capacity information from at least one other electronic device of the plurality of electronic devices;
using the synchronization module to issue a synchronization request based on the a synchronization setting information and the storage capacity information;
using the electronic device status management module to receive the storage capacity information; and
using the data synchronization management module to receive the synchronization request, and synchronize the data to at least one other electronic device of the plurality of electronic devices in accordance with the synchronization request.
